(19) United States
(12) Patent Application Publication
(10) Pub. No.: US 2008/0291773 A1
(43) Pub. Date: Nov. 27, 2008

(54) Soil Cement Manufacturing Machine Quipped with Impeller Having Scratching Blade

(76) Inventor: Tae-Hyung Lee, Gyeonggi-Do (KR)

Correspondence Address: IPLA P.A., 3580 WILSHIRE BLVD., 17TH FLOOR, LOS ANGELES, CA, 90010, US

(21) Appl. No.: 12/092,264

(22) PCT Filed: Oct. 31, 2006
(86) PCT No.: PCT/KR2006/004464

§ 371 Date: Apr. 30, 2008

(30) Foreign Application Priority Data
Nov. 1, 2005 (KR) 10-2005-0103629

(51) Int. Cl. B28C 5/14; B28C 5/08

(52) U.S. Cl. 366/66

(57) ABSTRACT

The present invention provides a soil cement manufacturing machine which prevents blades of an impeller from becoming worn and prevents soil cement from becoming stuck to and remaining in a mixing tub. The soil cement manufacturing machine includes an input part (100), which is provided for supplying soil and cement, and a mixing tub (210). The mixing tub (210) has an inlet port (220), an outlet port (230), through which mixed soil cement is discharged, and a nozzle (250) provided above the outlet port (230). The oil cement manufacturing machine further includes impellers (300), which are provided in the mixing tub (210) to mix soil and cement. Each impeller has a circular part (310) and blades (320), which are radially fastened to the circular plate. At least one impeller (300) has at least one blade which is longer than remaining blades thereof, and is provided with a scraping blade 330 having a T-shaped end.

### TECHNICAL FIELD

The present invention relates, in general, to soil cement manufacturing machines and, more particularly, to a soil cement manufacturing machine which prevents blades of an impeller from becoming worn and prevents soil cement from becoming stuck to and remaining in a mixing tub and from thus acting as an impediment to the rotating blades during operation.

### BACKGROUND ART

Soil cement manufacturing machines such as fan mixers are used to manufacture soil cement. However, because such machines merely agitate soil and cement, the soil and cement cannot be crushed and thus cannot be evenly mixed, thus resulting in poor soil cement.

In an effort to overcome the above problem, the inventor of the present invention proposed a soil cement manufacturing machine in Korean Utility Model Registration No. 20-0295234. FIG. 1 is a perspective view showing the conventional soil cement manufacturing machine disclosed in the above Utility Model. FIG. 2 is a perspective view showing impellers used in the conventional soil cement manufacturing machine. Referring to the drawings, the conventional soil cement manufacturing machine 1 includes an input part 10 and a mixing part 20.

The input part 10 includes a soil hopper 11 for supplying soil, a cement hopper 13 for supplying cement, and a conveyor 15, which carries supplied soil and cement into the mixing part.

The mixing part 20 includes two, that is, upper and lower, mixing tubs 23 and 25, which are provided at upper and lower positions to mix soil and cement supplied from the input part 10, impellers 40, which are provided in each mixing tub 23, 25 to crush and mix the soil and cement, and a drive means 30 for rotating the impellers.

The impellers 40 are fitted over drive shafts 31 and 33, which are longitudinally provided through the respective mixing tubs 23 and 25. Each impeller 40 includes a circular plate 41, which is fastened to the associated drive shaft 31, 33, and a plurality of blades 43, which are radially fastened to the circular plate 41, and each of which has a bent part on an end thereof.

In the conventional soil cement manufacturing machine 1 having the above-mentioned construction, soil and cement are first supplied into the upper mixing tub 23 through the input part and are crushed and mixed by the impellers 40, which are rotated by the drive means. The soil and cement thereafter fall into the lower mixing tub 25 through a falling hole, which is formed at a front position. The soil and cement, which have fallen, are further crushed and mixed in the lower mixing tub 25. Subsequently, the soil and cement are mixed with water and an aqueous solution containing additives, which are sprayed through a nozzle 29 provided above an outlet port, to have appropriate water content, and are discharged outside the mixing tub through the outlet port 27.

The conventional soil cement manufacturing machine consecutively conducts the crushing, mixing and discharging processes, thus enhancing the productivity and workability thereof.

Furthermore, in the conventional soil cement manufacturing machine, some of the blades of each impeller 40 are bent in the same direction as the direction in which the operation progresses, and the other blades are bent in the direction opposite the direction in which the operation progresses, thus preventing soil and cement from moving too rapidly, thereby sufficiently crushing and mixing soil and cement. However, in the case of this structure, the speed at which soil and cement are moved is too slow, and thus the productivity thereof is reduced. Furthermore, there is a problem in that soil and cement may remain in the mixing tubs 23 and 25. Particularly, around the outlet port 27 of the mixing tub, soil and cement, which are mixed with sprayed water and the aqueous solution containing the additives, may be stuck to the inner surface of the mixing tub 25, thus impeding the rotation of the impellers. As a result, an excessive rotating load is applied to the machine, and there is a problem in that the blades of the impellers 40 are easily worn by friction due to the stuck soil and cement.

### DISCLOSURE OF INVENTION

### Technical Problem

Accordingly, the present invention has been made keeping in mind the above problems occurring in the prior art, and an object of the present invention is to provide a soil cement manufacturing machine which prevents soil cement from remaining in a mixing tub and prevents blades of an impeller from becoming worn, thus extending the lifetime thereof, and increasing the productivity thereof.

### Technical Solution

In order to accomplish the above object, the present invention provides a soil cement manufacturing machine to prevent an impeller blade from becoming worn, including: an input part (100) provided for supplying soil and cement; a mixing tub (210), including an inlet port (220), through which the soil and cement are supplied from the input part (100), an outlet port (230), through which mixed soil cement is discharged, and a nozzle (250) provided at an adjacent position above the outlet port (230) to spray water and an additive; and a plurality of impellers (300) longitudinally arranged in the mixing tub (210) to mix and move the soil and cement, each of the impellers (300) including a circular part (310) coupled to a drive shaft (410), and a plurality of blades (320) radially fastened to the circular plate. At least one of the plurality of impellers (300) is an impeller (300), at least one blade of which is longer than remaining blades thereof, and which includes a scraping blade 330 having a T-shaped end.

### Advantageous Effects

The soil cement manufacturing machine according to the present invention prevents soil and cement from becoming stuck to the inner surface of a mixing tub, thus solving problems in which the space in the mixing tub is reduced by stuck soil and cement, it becomes difficult to move the soil cement due to the stuck soil and cement, which act as an impediment, and the blades of the impellers are worn by the friction of the stuck soil and cement. Thereby, the present invention can rapidly and efficiently manufacture soil cement, that is, can increase the productivity. Furthermore, the element replacement period is increased.

In a test, the conventional soil cement manufacturing machine manufactured 10 m3 of soil cement in one hour, while the soil cement manufacturing machine according to the present invention manufactured 20 m3 of soil cement in one hour. In the case of the conventional soil cement manufacturing machine, the blade replacement period thereof is three days, but that of the soil cement manufacturing machine of the present invention is twenty days or longer.

The scope of the present invention is defined by the accompanying claims, rather than being limited by the following embodiment. Furthermore, it is to be understood that various modifications, additions and substitutions that can be derived from the equivalent concepts of the accompanying claims fall within the bounds of the present invention.

### BRIEF DESCRIPTION OF THE DRAWINGS

FIG. 1 is a schematic view showing a conventional soil cement manufacturing machine;

FIG. 2 is a perspective view showing the impellers used in the conventional soil cement manufacturing machine;

FIG. 3 is a perspective view of a soil cement manufacturing machine according to the present invention;

FIG. 4 is a perspective view showing the impellers used in the soil cement manufacturing machine according to the present invention; and

FIGS. 5 and 6 are perspective views showing a scraping blade of the soil cement manufacturing machine of the present invention from different angles.

### BEST MODE FOR CARRYING OUT THE INVENTION

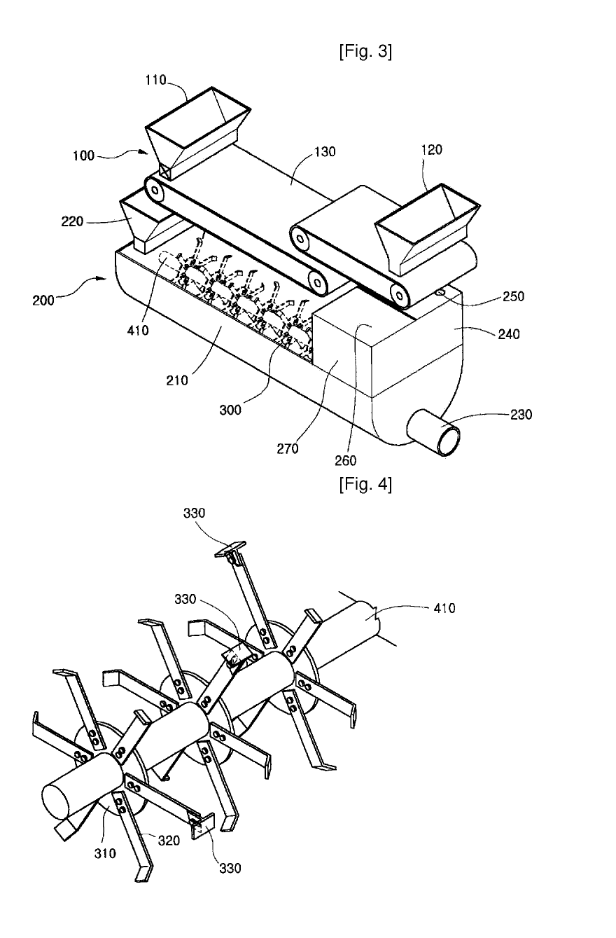

Hereinafter, a preferred embodiment of the present invention will be described in detail with reference to the attached drawings. FIG. 3 is a perspective view of a soil cement manufacturing machine according to the present invention. FIG. 4 is a perspective view showing impellers of the soil cement manufacturing machine according to the present invention. Referring to the drawings, the soil cement manufacturing machine of the present invention includes an input part 100 and a mixing part 200.

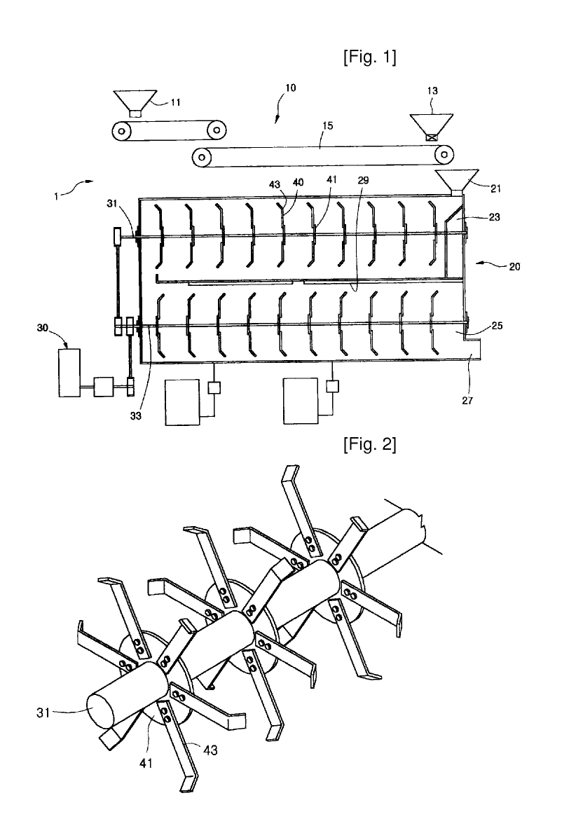

The input part 100 includes a soil hopper 110 and a cement hopper 120 for supplying soil and cement, and a conveyor belt 130, which carries soil and cement, supplied through the hoppers, to a mixing tub, in the same manner as that of a conventional soil cement machine. The construction of the hoppers and the conveyor and the coupling relationship therebetween are the same as those of the conventional soil cement machine of FIG. 1. Those skilled in the art will appreciate that various modifications to the construction of the input part are possible, and that the present invention is not characterized by the input part. Therefore, further explanation of the input part is deemed unnecessary.

The mixing part 200 includes the mixing tub 210, in which supplied soil and cement are mixed, impellers 300, which are provided in the mixing tub 210 to crush and mix the soil and cement, and a drive means 400 for rotating the impellers.

In this embodiment, the mixing tub 210 has a single-stage structure and has a semi-cylindrical shape, the bottom of which is round. Furthermore, the mixing tub 210 includes an inlet port 220, through which soil and cement are supplied into the mixing tub 210, and an outlet port 230, through which mixed soil cement is discharged. An open part 240, having a predetermined size, and a nozzle 250, which sprays water and additives, are provided above the outlet port 230 at adjacent positions.

The open part 240 has an opening 260, which is open at a predetermined position adjacent to the outlet port of the mixing tub 210, and a sidewall 270, which is provided around the opening 260 to a predetermined height. Here, the opening 260 is formed to prevent soil and cement, scattered in the mixing tub 210, from becoming stuck to the upper surface and thus remaining. The sidewall 270 of the open part 240 preferably has a height sufficient to prevent soil and cement from being scattered outside when the impellers 300 are rotated. The open part 240 is preferably manufactured in a circular or rectangular shape, but it is not limited to any particular shape.

The impellers 300, which are provided in the mixing tub 210, are coupled to a drive shaft 410. The drive shaft 410 is rotated using power transmitted from a drive means (not shown), which is provided outside the mixing tub 210. Each impeller 300 includes a circular plate 310, which is firmly fitted over the drive shaft 410, and a plurality of blades 320, which are radially fastened to the circular plate 310, and each of which has a bent part on an end thereof.

In this embodiment, each impeller has six blades, one of which is a scraping blade 330 that is longer than other blades and is made of material treated to have superior abrasion resistance. The scraping blade 330 has a length appropriate for scraping soil and cement, which are stuck to the inner surface of the mixing tub 210, when the impeller is rotated. In addition, the scraping blade 330 has a T shape to easily scrape the inner surface of the mixing tub.

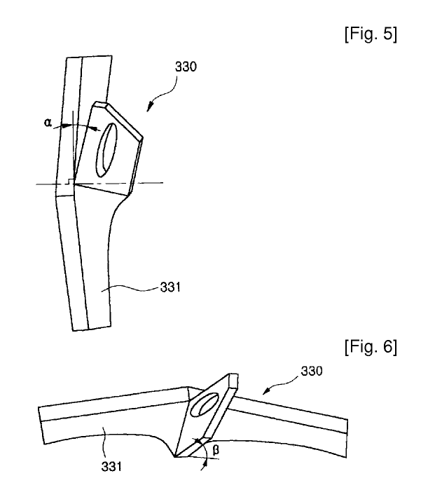

As shown in FIGS. 5 and 6, the scraping blade 330 is constructed such that a blade tip 331 thereof has an inclined scraping angle (α) ranging from 11° to 15° and has a discharge angle (β) ranging from 81° to 91°. If the upper limit values are exceeded, the discharge rate is increased, but crushing efficiency is reduced and the load is increased. Conversely, if actual values are less than the lower limit values, a low load is applied, but the discharge rate is reduced.

Here, the term ‘inclined scraping angle’ means the angle at which the scraping blade 330 scrapes and moves the stuck mixture upwards when rotating in a circumferential direction. The term ‘discharge angle’ means the angle at which the scraping blade 330 pushes the stuck mixture when rotating in a circumferential direction.

Here, it is preferable that the scraping blade 330 be heat-treated to have abrasion resistance superior to other blades.

Each of the other blades 320 is a blade, the end of which is simply bent. In this embodiment, the end of each blade 320 may be bent in the same direction in which soil and cement are carried. Alternatively, to adjust crushability depending on the length of the mixing tub, some of the bent parts may be bent in the direction opposite the direction in which soil and cement are carried.

The drive means 400 includes a typical rotating motor to rotate the impeller 300 through the drive shaft 410. Those skilled in the art will appreciate that various modifications of the construction of the drive means are possible, and the present invention is not characterized by the drive means. Therefore, further explanation of the input part is deemed unnecessary.

Furthermore, in the soil cement manufacturing machine of the present invention, a water and additive storing means for supplying water and additives and a device for connecting it to the soil cement manufacturing machine are easily implemented by those skilled in the art. The present invention is not characterized by the nozzle or by the water and additive storing means, therefore further explanation of the input part is deemed unnecessary.

The operation and effect of the embodiment of the present invention will be described herein below. In the machine according to the embodiment of the present invention, soil and cement are supplied into the mixing tub 210 through the input part 100 and are crushed and mixed by the impellers 300, which are rotated by the drive means 400. The soil and cement are mixed with water and additives, which are supplied through the nozzle 250 provided around the outlet port 230 of the mixing tub 210, to have appropriate water content, and are discharged outside the mixing tub through the outlet port 230.

During this process, the scraping blades 330 continuously scrape some soil and cement stuck to the inner surface of the mixing tub 210, thus markedly reducing the phenomenon in which soil and cement are stuck to the inner surface of the mixing tub.

Furthermore, soil and cement are mixed with water and additives around the outlet port 230, and thus have higher viscosity. Even though such soil and cement are scattered upwards by the impellers 300, because the upper end of the open part 220 provided around the outlet port 230 is open, soil cement again enters the mixing tub 210 without becoming stuck to the sidewall 270, thus preventing soil cement from becoming stuck to and remaining on the upper surface of the mixing tub 210.

Although the preferred embodiment of the present invention has been disclosed for illustrative purposes, various modifications, additions and substitutions are possible, without departing from the scope and spirit of the invention. For example, those skilled in the art will be able to easily modify the shape of the mixing tub, the angles at which the blades are bent, the position of the nozzle, the number of stages of the mixing tub (for example, it may be realized in two or three stages), the method of coupling the input part to the mixing tub, etc.

1. A soil cement manufacturing machine to prevent an impeller blade from becoming worn, comprising:
an input part (100) provided for supplying soil and cement;
a mixing tub (210), including an inlet port (220), through which the soil and cement are supplied from the input part (100), an outlet port (230), through which mixed soil cement is discharged, and a nozzle (250) provided at an adjacent position above the outlet port (230) to spray water and an additive; and
a plurality of impellers (300) longitudinally arranged in the mixing tub (210) to mix and move the soil and cements each of the impellers (300) including a circular part (310) coupled to a drive shaft (410), and a plurality of blades (320) radially fastened to the circular plate,
wherein at least one of the plurality of impellers (300) is an impeller (300), at least one blade of which is longer than remaining blades thereof, and which includes a scraping blade (330) having a T-shaped end.

2. The soil cement manufacturing machine according to claim 1, wherein the scraping blade (330) includes a blade tip, which has an inclined scraping angle ranging from 11° to 15° and a discharge angle ranging from 81° to 91°.

3. The soil cement manufacturing machine according to claim 1, wherein the mixing tub (210) further includes thereon an open part (240) having a length sufficient to prevent soil from being scattered outside, and wherein the nozzle (250) is disposed in an upper end of the open part at a position adjacent to the outlet port.

4. The soil cement manufacturing machine according to claim 1, wherein each of the impellers (300) has six blades, one of which has the scraping blade (330).

5. The soil cement manufacturing machine according to claim 2, wherein the mixing tub (210) further includes thereon an open part (240) having a length sufficient to prevent soil from being scattered outside, and wherein the nozzle (250) is disposed in an upper end of the open part at a position adjacent to the outlet port.
